(19) United States
(12) Patent Application Publication
(10) Pub. No.: US 2006/0070864 A1
(43) Pub. Date: Apr. 6, 2006

(54) Trip indicative rocker switch

(75) Inventors: Carlos Alberto Ferreira, Boksburg (ZA); Danny Hadary, Johannesburg (ZA); Johannes Adrian Owalgen, Boksburg (ZA); Manuel Fernando Vidal Ribeiro, Germiston (ZA)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: CIRCUIT BREAKER INDUSTRIES LTD, Gauteng (ZA)

(21) Appl. No.: 11/226,366

(22) Filed: Sep. 15, 2005

(30) Foreign Application Priority Data
Oct. 4, 2004 (ZA) 2004/7977

(51) Int. Cl. H01H 5/00

(52) U.S. Cl. 200/400

(57) ABSTRACT

A switch mechanism such as a circuit breaker includes a trip indicator mechanism. The switch mechanism includes a switch contact and a rocker movable between a first position in which the contacts are closed, a second position indicating that an electrical fault has occurred, in which the contacts are open, and a third position in which the switch mechanism has been reset and the contacts are open. The rocker preferably comprises two rocker members hinged together with one of the rocker members having a step formation between a front face and an end face. The step formation carries an instruction regarding resetting of the mechanism and lies substantially flush with the front panel of the circuit breaker housing, with the face of the first rocker member standing partially proud of the front panel, when the rocker is in the second position. The mechanism allows a user to distinguish between manual switching off of the circuit breaker and tripping due to a fault.

### BACKGROUND OF THE INVENTION

THIS invention relates to a switch mechanism including a trip indicator mechanism which can be used, for example, in circuit breakers and similar switch devices, and in particular in rocker switches.

The use of rocker switches in circuit breakers and other switch devices is well known. Conventionally, the rocker is fitted pivotally in an opening in a front panel of the circuit breaker housing and has two lobes which define faces which are inclined at an oblique angle relative to one another. Depending on whether the circuit breaker is on or off, one or the other of the lobes extends proud of the front panel of the circuit breaker, while the front face of the other lobe lies flush with the front panel.

In recent developments a rocker switch has been designed where the rocker includes first and second rocker members which are hinged together. The rocker members have flat front faces which are movable between a first position in which they lie flat in the same plane and a second position in which the faces are inclined relative to one another, with one rocker member standing proud of the housing of the switch.

A need has been identified for a switch mechanism of the above kind which would indicate that a fault has occurred within the electrical circuit, i.e. which includes a trip indicator.

It is an object of the invention to provide such a mechanism.

### SUMMARY OF THE INVENTION

According to the invention there is provided a switch mechanism including a trip indicator mechanism, the switch mechanism comprising switch contacts and a rocker movable between a first position in which the contacts are closed; a second position indicating that an electrical fault has occurred in a circuit associated with the switch mechanism and in which the contacts are open; and a third position in which the switch mechanism has been reset and the switch contacts are open, wherein, once in the second position, the rocker has to be moved to the third position before the switch mechanism can be operated to close the contacts.

The rocker may include first and second rocker members mountable movably relative to one another on a switch housing, at least one of the first and second rocker members being connectable to the switch mechanism thereby to operate the switch mechanism, the first and second rocker members each defining a front face, wherein the front faces of the first and second rocker members are substantially parallel in their respective first positions and are inclined relative to one another in their respective second and third positions.

The front faces of the first and second rocker members are preferably inclined relative to one another at respective different angles when in their second and third positions.

Preferably, the rocker members are connectable hingedly together.

The first and second rocker members may have front faces of different colours.

For example, the first and second rocker members may be moulded in different coloured plastics material.

In a preferred embodiment of the invention the first rocker member has a step formation between its front face and an end face thereof.

The step formation of the first rocker member may carry an instruction, such as “pull to reset”.

The rocker members may be mounted in an opening defined in a front panel of a circuit breaker housing, so that when the front faces of the rocker members are substantially parallel in the position thereof in which the switch contacts are closed, they are substantially flush with the edges of the opening.

Preferably, when the front faces of the first and second rocker members are in their respective second positions and are inclined relative to one another, the face of the step formation of the first rocker member and the front face of the second rocker member are substantially flush with the front panel of the circuit breaker housing, so that the first rocker member stands partially proud of the front panel.

Further, when the front faces of the first and second rocker members are in their respective third positions and are inclined relative to one another, the front face of the second rocker member is preferably substantially flush with the front panel of the circuit breaker housing and the face of the step formation of the first rocker member stands proud of the front panel of the circuit breaker housing.

The switch mechanism may include a trip test button adjacent to the rocker and arranged to trip the switch mechanism when the rocker is in its first position, to cause the contacts to open and the rocker to move to its second position.

The switch mechanism will typically comprise a circuit breaker.

### BRIEF DESCRIPTION OF THE DRAWINGS

FIG. 1 is a pictorial view of a circuit breaker including a trip indicator mechanism according to the invention with its operating switch in an “On” position;

FIG. 2 is a similar view to that of FIG. 1, with the switch in a “Tripped” position;

FIG. 3 is yet another similar view to that of FIG. 1 and 2, with the switch in a “Reset/Off” position;

FIG. 4 is a pictorial view of a first rocker member forming part of the trip indicator mechanism with one end having a step formation;

FIG. 5 is a pictorial view of a second rocker member forming part of the trip indicator mechanism;

FIG. 6 is a pictorial view of a test button forming part of the trip indicator mechanism;

FIG. 7 is a sectional side view of the circuit breaker of FIGS. 1 to 3 in an “On” position;

FIG. 8 is a similar view to that of FIG. 7, with the circuit breaker in a “Tripped” position; and

FIG. 9 is yet another similar view to that of FIGS. 7 and 8, with the circuit breaker in a “Reset/Off” position.

### DESCRIPTION OF PREFERRED EMBODIMENTS

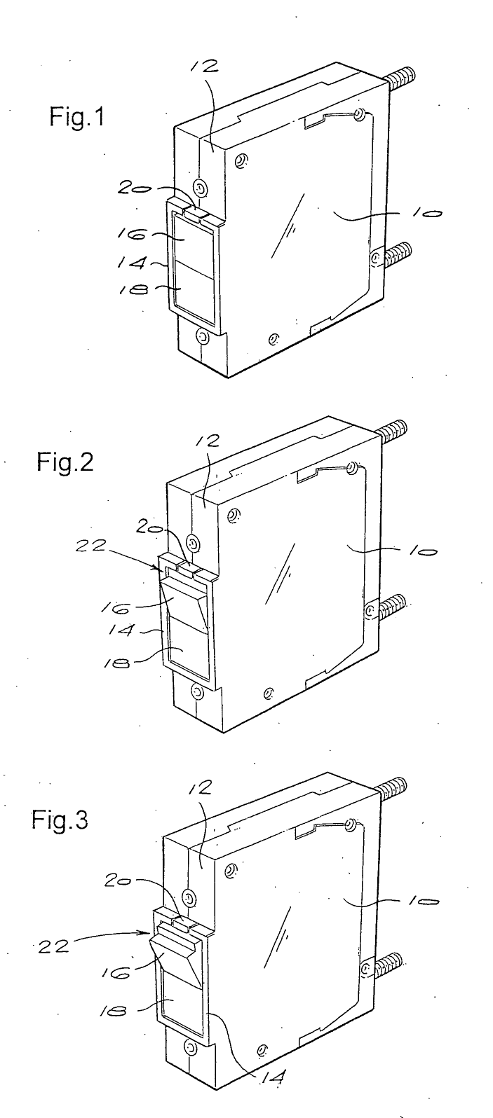

The FIGS. 1, 2 and 3 show a miniature circuit breaker incorporating a switch actuator and a trip indicator mechanism according to the invention. A miniature circuit breaker incorporating a switch actuator of this general kind is described in South African patent no. 2002/7064.

The circuit breaker of the invention comprises a moulded plastics housing 10 which is generally conventional and which has a parallelepipedic shape. The housing has a front panel 12 with a rectangular central aperture defined by a raised border 14. Within the aperture is located a rocker comprising first and second rocker members or lobes 16 and 18 respectively, while a trip test button 20 is located in the raised border 14. In the preferred embodiment of the invention, the rockers are moulded from different coloured plastics material (or otherwise colour coded differently) in order to distinguish which portion of the rocker switches the circuit breaker on and which switches it off. In the preferred embodiment, the upper rocker portion 16 was coloured white, while the lower rocker portion 18 was coloured red.

In FIG. 1, the rocker of the circuit breaker is in a first or “On” position with the circuit breaker contacts closed, and both the rocker members 16 and 18 lie substantially flush with the raised border 14 of the front plate 12.

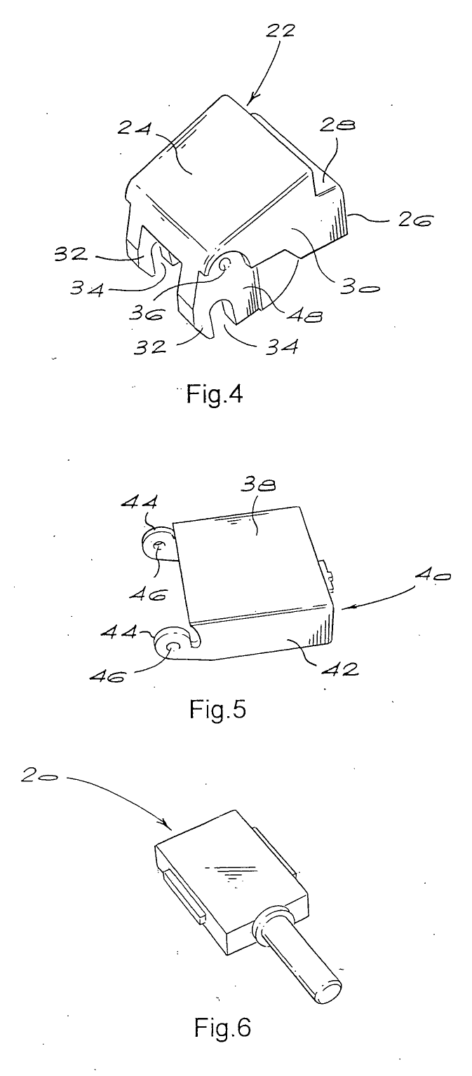

In FIG. 2, the rocker is in a second or “Tripped” position, and the first rocker member 16, which defines the upper lobe of the rocker, stands proud of the front plate 12 of the housing, extending beyond the raised border 14. As is best shown in FIG. 4, the first rocker member 16 has a step formation 22 between a flat front face 24 and a curved end face 26. The step formation 22 has a front face 28 that is parallel to the face 24 of the rocker member and a face that is substantially parallel with the end face 26 of the rocker. The front face 28 of the step formation 22 carries an instruction, such as “Pull to Reset”, which is clearly visible from the front of the circuit breaker with the rocker in the “Tripped” position. When in the “Tripped” position, the step formation's front face 28 lies substantially flush with the raised border 14. It will be appreciated that, when the rocker is in the “On” position with the flat front face 24 of the first rocker member 16 lying flush with the front plate 12, the step formation 22 and the instructions thereon are obscured from sight.

In FIG. 3, the rocker is in a third or “Reset/Off” position. In this position both the front face 24 and the face 28 of the step formation 22 of the first rocker member 16 stand proud of the front plate 12 and the raised border 14.

FIGS. 4 and 5 illustrate the arrangement of the rocker members and the trip indicator mechanism in more detail. FIG. 4 shows the first rocker member 16 with its flat front face 24 and curved end face 26, the step formation 22 with its front face 28, and a pair of parallel side faces 30 each having a recessed portion 48. Depending from the recessed portions 48 of the respective side faces 30 and formed integrally therewith are a pair of fingers 32, each of which defines a slot 34 at the end thereof furthest from the front face 24 and an aperture 36 at the other end thereof, adjacent the front face 24.

The second rocker member shown in FIG. 5 is shaped complementally, with a flat front face 38, an end face 40 and parallel side faces 42. Two ears 44, each with an aperture 46, extend from the parallel side faces 42. In use the two ears 44 capture the sides of the first rocker member 16, with the recessed portions 48 of the parallel side faces 30 fitting snugly between the ears 44. The apertures 46 of the ears 44 are aligned with the apertures 36 of the when the two rocker members 16 and 18 are correctly aligned.

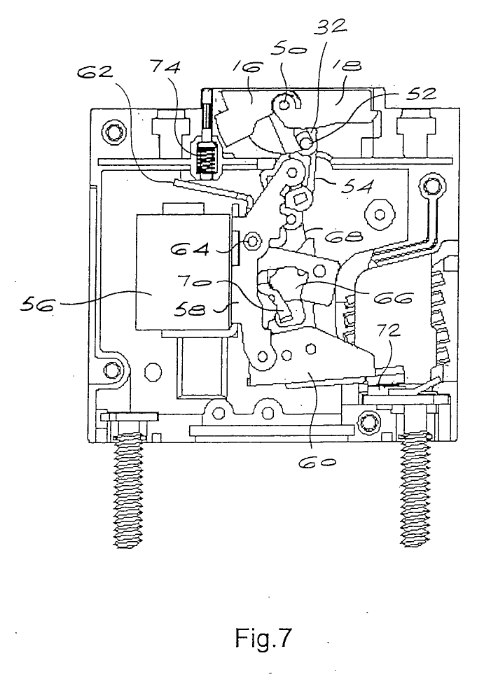

As is best shown in FIGS. 7 to 9, a metal pin 50, which is held captive by the inner walls of the housing 10 when the switch mechanism is assembled, holds the two rocker members hingedly together. The slots 34 at the ends of the fingers 32 engage opposite ends of a pin 52 which is carried at one end of a pivoting switch link member 54 forming part of the circuit breaker actuating mechanism.

The interaction between the rocker and the circuit breaker mechanism is conventional, but is described in detail according to FIGS. 7 to 9, to fully explain how the trip indicator and circuit breaker mechanism work.

The circuit breaker mechanism of the invention comprises a cylindrical coil 56 disposed coaxially about a non-magnetic tube (not shown) holding a cylindrical core, which is held in place by a frame member 58. The upper end of the frame member 58 is connected to a central portion of the switch link member 54. The lower end of the frame member 58 is connected to a movable contact 60, while an armature 62 is pivotally connected by a pin 64 to the middle section of the frame member 58. A sleeve link 66 is pivotally connected to a central portion of the movable contact 60, while the sleeve link 66 is connected to an interlink member 68. The interlink member 68 is in turn connected, at its other end, to the switch link member 54. Those skilled in the art will appreciate that the first rocker member 16 rotates about the pin 50 (from the “On” position, to the “Tripped” position, to the “Off” position), and describes, with the ends of the fingers 32, an arc, moving the end of the switch link member 54 carrying the pin 52.

In the “On” position, as shown in FIG. 7, the fingers 32 of the first rocker member 16 hold the switch link member 54 at one end of the described arc, with the switch link member 54, interlink member 68 and sleeve member 66 aligning to form a substantially straight formation connected to the middle of the movable contact 60. The foot portion of the armature 62 holds a catch 70 in place, which in turn keeps the switch link member 54, interlink member 68 and sleeve member 66 in position, with the movable contact 60 being in contact with a fixed contact 72. This interconnection of the switch link member 54, interlink member 68, sleeve member 66 and catch 70 forms a latching mechanism locking the switch actuator in the “On” position.

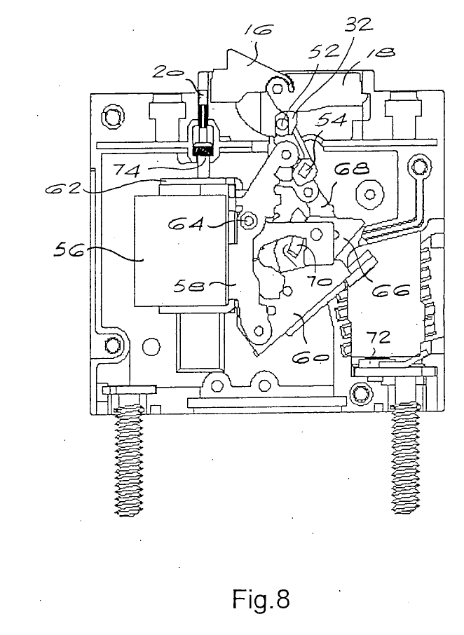

Turning to FIG. 8, the trip test button 20 is shown in an actuated position, pressed against the urging of a spring 74, with the lowermost end of the button 20 pushing down on the head of the armature 62. As the head of the armature 62 moves down, the foot portion of the armature 62 releases the catch 70, causing the switch link member 54 and the interlink member 68, as well as the sleeve member 66 to move away from the frame 58. This movement allows the movable contact 60 to move away from the fixed contact 72, opening the contacts and tripping the circuit breaker. The use of the trip test button 20 is advantageous as it allows for the commissioning of the circuit breaker after its installation.

After operation of the trip test button (or tripping of the circuit breaker due to a fault) the circuit breaker is now in a “Tripped” condition, with the upper rocker member 16 standing partially proud of the front face 12 and with the face 28 of the step formation 22 being flush with the raised border 14. In this condition, the circuit breaker cannot be operated, as movement of the upper rocker member 16 only moves the switch link member 54, the interlink member 68 and the sleeve member 66 partially toward the frame 58, without moving the catch 70. The circuit breaker has to be reset first, before it can be switched on.

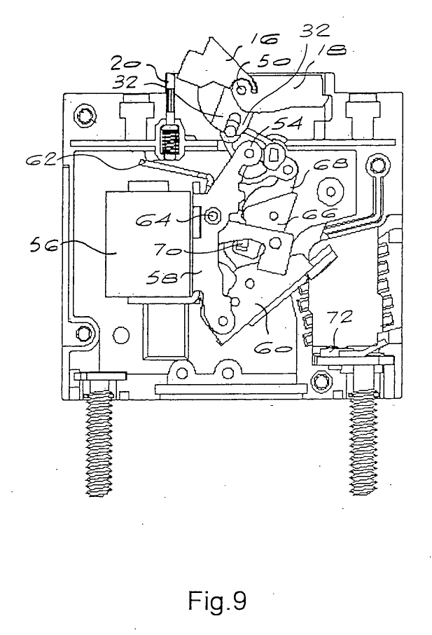

FIG. 9 shows the circuit breaker mechanism in a “Reset/Off” position, corresponding to the status of the mechanism as shown in FIG. 3. This position is obtained by pulling the step formation 22 of the first rocker member 16 outwardly away from the circuit breaker. This movement moves the fingers 32 of the first rocker member 16 toward the trip test button 20, with the connection between the switch link member 54 and the interlink member 68 being moved towards the second rocker member 18. This in turn pulls the interlink member 68 and the sleeve member 66 into alignment and moves the catch 70 closer to the frame member 58. The contacts remain open. With the interlink member 68 and the sleeve member 66 in alignment, pressing down on the first rocker member 16 moves the fingers 32 away from the trip test button 20. This straightens the switch link member 54, interlink member 68 and sleeve member 66 into an aligned formation, moving the catch 70 into position to be caught by the foot portion of the armature 62, with the movable contact 60 now moving towards the fixed contact 72, thereby closing the contacts and switching the circuit breaker on.

The second rocker member 18 is biased outwardly by a coil spring which locates about an upstanding boss formed on the inner surface of the second rocker member 18. When the circuit breaker is switched on by depressing the first rocker member 16, the latching mechanism locks the first rocker member in the position shown in FIG. 4, so that its front face 24 is substantially parallel with the front face 38 of the second rocker member 18.

As illustrated, the two front faces lie flush with the upper edge of the border 14, but it will be appreciated by those skilled in the art that the positioning of the rocker members could be varied somewhat according to aesthetic and practical considerations.

To turn the circuit breaker off, a pressure is applied to the second rocker member 18. This causes the rocker member to move inwards against the urging of the spring 54, rotating the switch link member 54 away from the frame member 58, thereby releasing the latching mechanism and allowing the first rocker member 16 to return to its “Off” position. The rotation of the switch link member 54 also moves the interlink member 68 and the sleeve member 66 connected to the movable contact 60 towards the rocker members, thereby opening the contacts of the circuit breaker.

The trip indicator mechanism provides a mechanism that indicates to a user when a fault has occurred within the electrical circuit. It further provides a switch mechanism which requires a reset action between a “Tripped” position and a “Reset/Off” position, before the switch can be switched on again. The mechanism allows a user to distinguish between manual switching off of the circuit breaker and tripping due to a fault.

The trip test button of the described trip indicator mechanism allows for the circuit breaker to be tested after its installation.

The described trip indicator mechanism and associated circuit breaker are aesthetically attractive and compact, and also solve the problem of inadvertent switching off of a circuit breaker due to its operating handle protruding from the casing thereof.

It will be understood by those skilled in the art that the invention can be applied to other switch mechanisms, having one or more sets of contacts, and is not limited to use with circuit breakers.

We claim:

1. A switch mechanism including a trip indicator mechanism, the switch mechanism comprising switch contacts and a rocker movable between a first position in which the contacts are closed; a second position indicating that an electrical fault has occurred in a circuit associated with the switch mechanism and in which the contacts are open; and a third position in which the switch mechanism has been reset and the switch contacts are open, wherein, once in the second position, the rocker has to be moved to the third position before the switch mechanism can be operated to close the contacts.

2. A switch mechanism according to claim 1 wherein the rocker includes first and second rocker members mountable movably relative to one another on a switch housing, at least one of the first and second rocker members being connectable to the switch mechanism thereby to operate the switch mechanism, the first and second rocker members each defining a front face, wherein the front faces of the first and second rocker members are substantially parallel in their respective first positions and are inclined relative to one another in their respective second and third positions.

3. A switch mechanism according to claim 2 wherein the front faces of the first and second rocker members are inclined relative to one another at respective different angles when in their second and third positions.

4. A switch mechanism according to claim 2 wherein the rocker members are connectable hingedly together.

5. A switch mechanism according to claim 2 wherein the first and second rocker members have front faces of different colours.

6. A switch mechanism according to claim 5 wherein the first and second rocker members are moulded in different coloured plastics material.

7. A switch mechanism according to claim 2 wherein the first rocker member has a step formation between its front face and an end face thereof.

8. A switch mechanism according to claim 7 wherein the step formation of the first rocker member carries an instruction.

9. A switch mechanism according to claim 8 wherein the instruction states “pull to reset”.

10. A switch mechanism according to claim 2 wherein the rocker members are mounted in an opening defined in a front panel of a circuit breaker housing, so that when the front faces of the rocker members are substantially parallel in the position thereof in which the switch contacts are closed, they are substantially flush with the edges of the opening.

11. A switch mechanism according to claim 10 wherein, when the front faces of the first and second rocker members are in their respective second positions and are inclined relative to one another, the face of the step formation of the first rocker member and the front face of the second rocker member are substantially flush with the front panel of the circuit breaker housing, so that the first rocker member stands partially proud of the front panel.

12. A switch mechanism according to claim 11 wherein, when the front faces of the first and second rocker members are in their respective third positions and are inclined relative to one another, the front face of the second rocker member is substantially flush with the front panel of the circuit breaker housing and the face of the step formation of the first rocker member stands proud of the front panel of the circuit breaker housing.

13. A switch mechanism according to claim 1 including a trip test button adjacent to the rocker and arranged to trip the switch mechanism when the rocker is in its first position, to cause the contacts to open and the rocker to move to its second position.

14. A switch mechanism according to claim 1 which comprises a circuit breaker.
